(19) United States
(12) Patent Application Publication
(10) Pub. No.: US 2026/0110240 A1
(43) Pub. Date: Apr. 23, 2026

(54) SYSTEM AND METHOD FOR ON-DEMAND AUTONOMOUS PRECISION INFILL DRILLING

(71) Applicant: SCHLUMBERGER TECHNOLOGY CORPORATION, Sugar Land, TX (US)

(72) Inventors: Shi SU, Aby Dhabi (AE); Samat RAMATULLAYEV, Aby Dhabi (AE); Hussein MUSTAPHA, Aby Dhabi (AE)

(21) Appl. No.: 19/153,038

(22) PCT Filed: Mar. 20, 2024
(86) PCT No.: PCT/US2024/020713

§ 371 Date: Aug. 1, 2025

Related U.S. Application Data
(60) Provisional application No. 63/491,149, filed on Mar. 20, 2023.

(51) Int. Cl. E21B 43/16

(52) U.S. Cl. CPC E21B 43/16; E21B 2200/20

(57) ABSTRACT

A method for autonomously simulating infill drilling of one or more wells includes calculating a plurality of connected volumes in a reservoir model. The method also includes determining that a total hydrocarbon production of one or more existing wells inside the reservoir model has decreased below a predetermined hydrocarbon production threshold. The method also includes determining that one or more drilling rigs have a capacity to support drilling a first new well in response to determining that the total hydrocarbon production has decreased below the predetermined hydrocarbon production threshold. The first new well is a production well. The method also includes determining an opportunity index in response to determining that one or more drilling rigs have the capacity. The method also includes identifying a target in the opportunity index. The method also includes placing the first new well in the reservoir model in response to identifying the target.

### CROSS-REFERENCE TO RELATED APPLICATIONS

This application claims priority to U.S. Provisional Patent Application No. 63/491,149, filed on Mar. 20, 2023, the entirety of which is incorporated by reference herein.

### BACKGROUND

Infill drilling refers to the addition of one or more wells in a field that decreases the average well spacing. This practice both accelerates the expected recovery and increases the estimated ultimate recovery in heterogeneous reservoirs by improving the continuity between injectors and producers.

Conventional industry practices use infill drilling for field development plan optimization with reservoir simulations. This includes designing new production wells and/or injection wells, adding them to a reservoir simulation model, performing the reservoir simulation, and assessing the results. This process uses drilling queues to automate the process of opening the designed wells at a time when the production of the reservoir declines from the target defined.

However, the placement of the wells is performed by an engineer through an analysis that is based on the simulation results, which is manual and time-consuming. The reservoir simulation is then run with the given wells without the ability to change their location and without the ability to create new wells during the reservoir simulation itself. Additionally, the designed wells may not be optimal at the given time when they are to be opened. Furthermore, the automation of the opening schedule of the injection wells during the simulation is usually not considered. Thus, conventional automated systems for performing well placement optimization may not dynamically capture the optimal locations for infill drilling.

### SUMMARY

A method for autonomously simulating infill drilling of one or more wells is disclosed. The method includes calculating a plurality of connected volumes in a reservoir model. The method also includes determining that a total hydrocarbon production of one or more existing wells inside the reservoir model has decreased below a predetermined hydrocarbon production threshold. The method also includes determining that one or more drilling rigs have a capacity to support drilling a first new well in response to determining that the total hydrocarbon production has decreased below the predetermined hydrocarbon production threshold. The first new well is a production well. The method also includes determining an opportunity index in response to determining that one or more drilling rigs have the capacity. The method also includes identifying a target in the opportunity index. The method also includes placing the first new well in the reservoir model in response to identifying the target.

A computing system is also disclosed. The computing system includes one or more processors and a memory system including one or more non-transitory computer-readable media storing instructions that, when executed by at least one of the one or more processors, cause the computing system to perform operations. The operations include calculating a plurality of connected volumes. The connected volumes are calculated based upon a transmissibility in a grid. The grid includes a plurality of grid cells in a reservoir model. The connected volumes comprise the grid cells in the reservoir model that are hydraulically connected. Each wherein each grid cell includes a plurality of properties. The properties include porosity, permeability, saturation, or a combination thereof. The operations also include performing a first time step in a simulation. The first time step is performed after calculating the plurality of connected volumes. Performing the first time step includes determining that a total hydrocarbon production of one or more existing wells inside the reservoir model has decreased below a predetermined hydrocarbon production threshold. The total hydrocarbon production is a rate at which hydrocarbons are produced. Performing the first time step also includes determining that one or more drilling rigs have a capacity to support drilling a first new well in response to determining that the total hydrocarbon production has decreased below the predetermined hydrocarbon production threshold. The first new well is a production well. Performing the first time step also includes determining an opportunity index in response to determining that one or more drilling rigs have the capacity. Performing the first time step also includes identifying a target in the opportunity index. Performing the first time step also includes placing the first new well in the reservoir model in response to identifying the target.

A computer program is also disclosed. The computer program includes instruction that, when executed by a computer processor of a computing device, cause the computing device to perform operations. The operations include calculating a plurality of connected volumes. The connected volumes are calculated based upon a transmissibility in a grid. The grid includes a plurality of grid cells in a reservoir model. The connected volumes include the grid cells in the reservoir model that are hydraulically connected. Each grid cell includes a plurality of properties. The properties include porosity, permeability, saturation, or a combination thereof. The operations also include performing a first time step in a simulation. The first time step is performed after calculating the plurality of connected volumes. Performing the first time step includes determining that a total hydrocarbon production of two or more existing wells inside the reservoir model has decreased below a predetermined hydrocarbon production threshold. The total hydrocarbon production is a rate at which hydrocarbons are produced. Performing the first time step also includes determining that one or more drilling rigs have a capacity to support drilling a first new well in response to determining that the total hydrocarbon production has decreased below the predetermined hydrocarbon production threshold. The first new well is a production well. Performing the first time step also includes determining an opportunity index in response to determining that one or more drilling rigs have the capacity. The opportunity index is based upon the properties of the grid cells and one or more constant values that are unrelated to the properties of the grid cells. Performing the first time step also includes identifying a target in the opportunity index. The target includes one or more values in the opportunity index that are greater than a predetermined opportunity index threshold. Performing the first time step also includes placing the first new well in the reservoir model in response to identifying the target. The first new well is placed as part of a predetermined pattern in the target or by itself in the target. The first new well is placed so as to not collide or interfere with the two or more existing wells. Performing the first time step also includes assigning controls to the first new well. The controls include production rate limits and pressure limits. Performing the first time step also includes determining that the total hydrocarbon production of a combination of the two or more existing wells and the first new well in the reservoir model is greater than the predetermined hydrocarbon production threshold after assigning the controls. The operations also include performing a second time step in the simulation in response to determining that the total hydrocarbon production of the combination of the two or more existing wells and the first new well in the reservoir model is greater than the predetermined hydrocarbon production threshold.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A, 1B, 1C, 1D, 2, 3A, and 3B illustrate simplified, schematic views of an oilfield and its operation, according to an embodiment.

FIG. 4 illustrates a diagram of production wells infill drilling workflow, according to an embodiment.

FIG. 5 illustrates a diagram of injection wells infill drilling workflow, according to an embodiment.

FIGS. 6A and 6B illustrate a flowchart of a method for infill drilling, according to an embodiment.

FIG. 7 illustrates a computing system for performing at least a portion of the method(s) disclosed herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of the invention. The first object and the second object are both objects, respectively, but they are not to be considered the same object.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

The present disclosure describes a system and method that may improve field development planning (e.g., optimization) with reservoir simulation workflows. More particularly, during a reservoir simulation process, if the user's production targets are not met, the system and method can automatically identify a (e.g., best) location for a new well, plan the (e.g., optimal) trajectory for the new well, and add it to the simulation to achieve the production targets. This may include autonomously and dynamically locating and placing new infill wells (e.g., producers and/or injectors) without having a user (e.g., manually) pre-design or pre-plan the wells in advance. The system and method can be used for a single reservoir and scaled up to reservoirs with multiple zones or multi-stacked reservoirs.

### System Overview

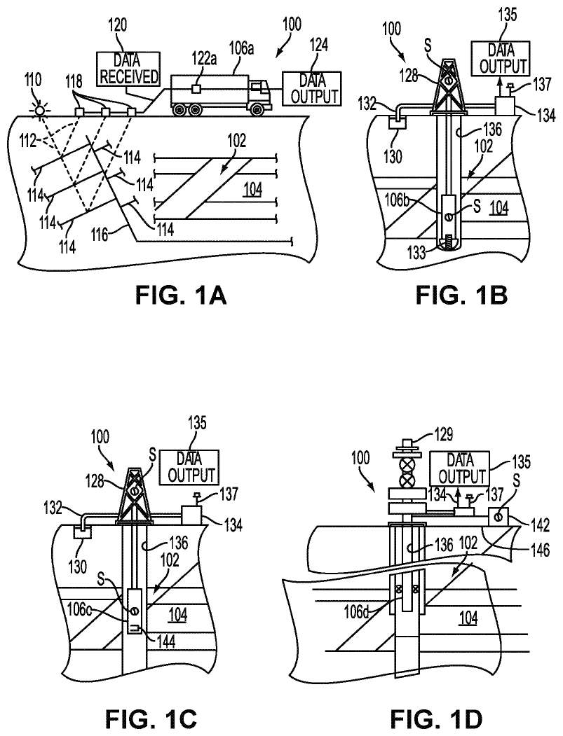

FIGS. 1A-1D illustrate simplified, schematic views of oilfield 100 having subterranean formation 102 containing reservoir 104 therein in accordance with implementations of various technologies and techniques described herein. Although embodiments of the present method are at least partially described herein with reference to an oilfield, it will be appreciated that this is merely an illustrative example. Embodiments of the present method may be employed in any application in which visualizing, modeling, or otherwise identifying subsurface features (e.g., geological features) may be useful. Examples outside of the oilfield context include subsurface mapping for wind arrays and/or solar arrays, geothermal energy production, mining operations, offshore/deep ocean applications, etc.

FIG. 1A illustrates a survey operation being performed by a survey tool, such as seismic truck 106.1, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1B illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected.

The data gathered by sensors (S) may be collected by surface unit 134 and/or other data collection sources for analysis or other processing. The data collected by sensors(S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106.3 suspended by rig 128 and into wellbore 136 of FIG. 1B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 1A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 1D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors(S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

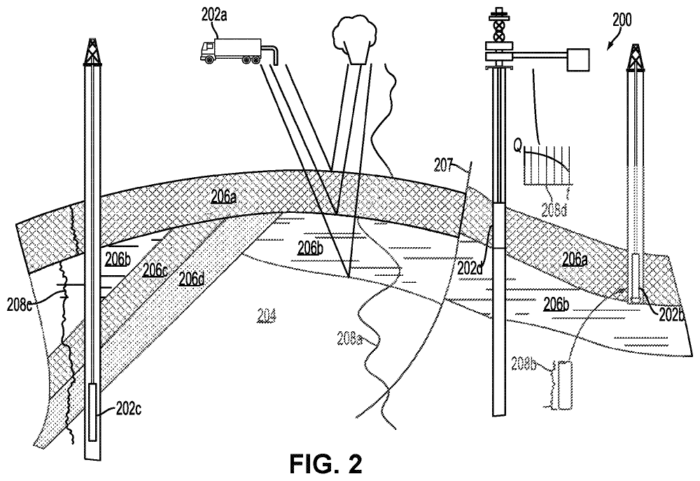

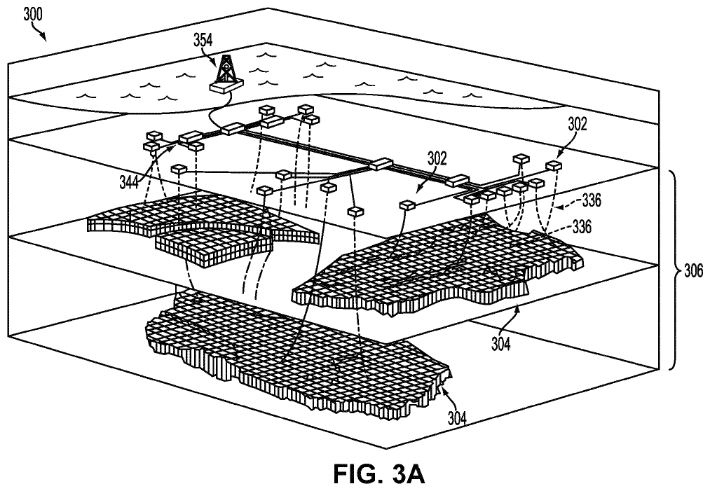

FIG. 2 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1A-1D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively; however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that typically provides a resistivity or other measurement of the formation at various depths.

A production decline curve or graph 208.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208.1 from data acquisition tool 202.1 is used by a geophysicist to determine characteristics of the subterranean formations and features. The core data shown in static plot 208.2 and/or log data from well log 208.3 are typically used by a geologist to determine various characteristics of the subterranean formation. The production data from graph 208.4 is typically used by the reservoir engineer to determine fluid flow reservoir characteristics. The data analyzed by the geologist, geophysicist and the reservoir engineer may be analyzed using modeling techniques.

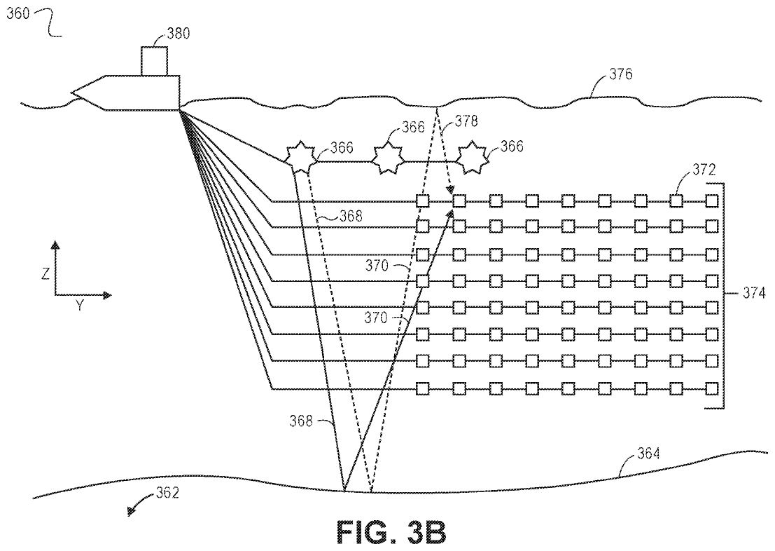

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subterranean subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90 Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Marine seismic acquisition systems tow each streamer in streamer array 374 at the same depth (e.g., 5-10 m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

### On-Demand Autonomous Precision Infill Drilling System

The system and method may fully automate infill drilling while the simulation is running, and no infill wells may be provided (e.g., manually) by the engineer, because the wells may be designed (e.g., optimally) by the system based on the reservoir conditions such as when new wells would be useful. More particularly, when the production capacity of existing wells is not enough to sustain the production target, a new well may be drilled. This may include evaluating reservoir opportunities based on a user-defined opportunity index (or a machine-learning system to be defined). Then, potential targets may be filtered, and automated well placement and trajectory design may be performed in the target. The target may be a connected volume of high opportunity. The well may then be put on production.

In one embodiment, injection wells may be paired with production wells based on the distance between the wells. The injection wells may be opened before, simultaneously with, or after the associated production wells are opened. However, the contribution of the injection well(s) to the production well(s) may not be considered.

The infill drilling may have a functionality to consider rig availability and drilling time to consider operational constraints and limited resources in the field. Automated infill drilling of injectors may include multiple considerations. One consideration may be to sustain the pressure in the reservoir. This may include identifying pressure sinks in the reservoir. This may also include identifying a volume that connects to the pressure sink. This may also include determining the minimum distance to be respected to the existing wells. This may also include testing different possible injection well locations by determining streamlines to then determine the location with highest concentration of streamlines passing through the zone to repressurize.

Another consideration may include supporting production wells. For example, if a production well is placed, it may be paired with an injector at a certain distance (e.g., pattern like injection). In another example, the production wells may be supported conditionally (e.g., if there is no injection well that will be supporting the new producer sufficiently). The production wells may also be supported using patterns.

Another consideration may include one or more possible patterns for the infill wells to be placed. In one embodiment, there may be no pattern. Rather, the wells may be defined (e.g., solely) based upon the (e.g., best) identified location. In another embodiment, there may be vertical well patterns (e.g., 4-, 5-, 7-, 9-spot patterns, inverted patterns, etc.). In another embodiment, there may be horizontal wells patterns (e.g., line drive, direct, staggered, etc.).

The system and method may include multiple portions. One portion may be or include target identification and/or infill production well placement on-the-fly during simulation. More particularly, while running a simulation for a production forecast, if the production capacity of the existing wells is not sufficient, the system and method may automatically perform target identification based on user-defined criteria (e.g., an opportunity index) and place a well to target the (e.g., best) identified area.

Another portion may be or include automated injection well placement on-the-fly during simulation. More particularly, injection wells can be placed while the simulation is running based on the existing producers'constraints (e.g., pressure maintenance, oil displacement). Streamlines-based calculations can be performed to determine where injection wells can be placed or to which producers'injection wells should be paired to for a predetermined (e.g., optimal) impact on the producer.

The fully automated system and method may help reservoir engineers by accelerating (and optimizing) field development planning through reservoir simulation. The system and method may adapt to the constantly-changing fluid dynamics of the reservoir in real-time and rely on predetermined well trajectories and drilling queue logic, leading to (e.g., optimal) well placement. Conventional systems and methods cannot do this and thus lead to suboptimal well placement. Additionally, conventional systems and methods are excessively manual and time-consuming.

The system and method may provide a fully automated, autonomous, and on-the-fly technique to perform infill drilling for field development planning optimization, directly embedded in reservoir simulation, that does not involve any manual intervention from the user. The system and method may be used for field development plan optimization by reservoir engineers in oil and gas operating companies and consultants. The system and method may be integrated into the INTERSECT® reservoir simulator. The system and method may provide a unique offering that includes performing on-demand infill drilling during reservoir simulation, including target identification, well placement and/or design, and providing improved facilities for injection well drilling scheduling when compared to existing technology. A product incorporating this system and method may have a value proposition over existing technology as it may assist engineers in accelerating the field development plan optimization process by fully automating the process and provide optimal field development plans with reduced efforts and time.

### Production Wells Infill Drilling Workflow

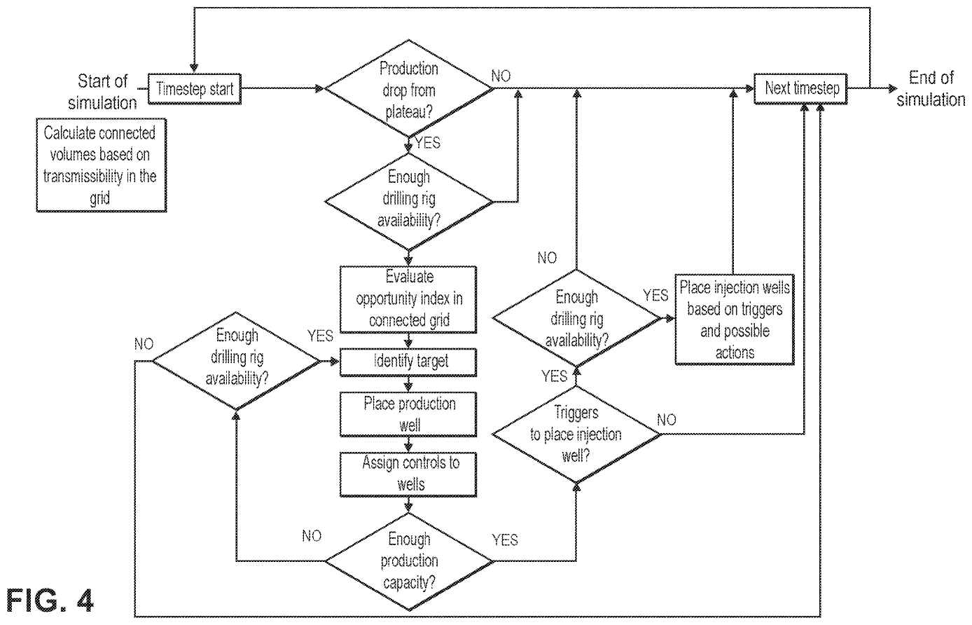

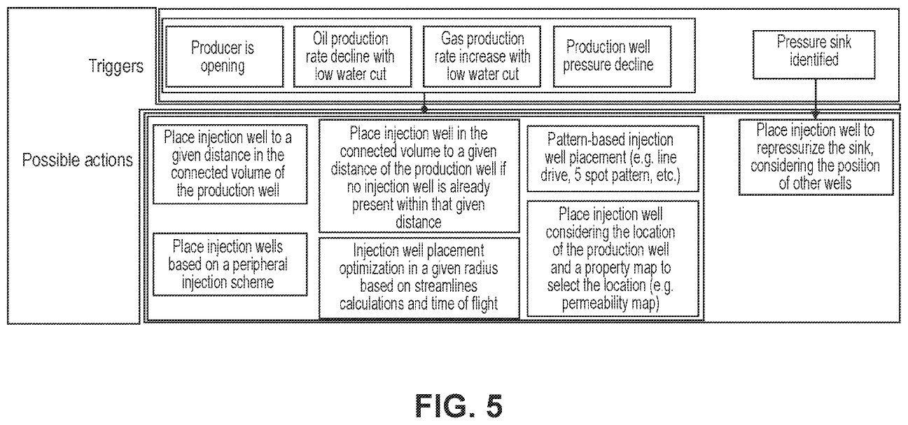

FIG. 4 illustrates a diagram of production wells infill drilling workflow, according to an embodiment. More particularly, FIG. 4 shows the procedure followed during the reservoir simulation to determine whether new infill wells should be designed and included at a given timestep. For each timestep during the simulation, multiple conditions (e.g., production dropping from a given plateau rate, drilling rig availability) may be checked to determine if a new production infill well should be added to meet production conditions and if the well can effectively be drilled due to constraints in field operations. If the conditions are met, a tri-dimensional opportunity index property representing areas with good quantities of produceable hydrocarbons may be built and used to filter targets where the well will be placed in the simulation model. Iteratively, if the designed well is not sufficient to fulfil the production conditions defined, the drilling constraints may be checked again, and another well may be placed in the simulation model, until the production conditions are met. Once the production capacity is met or drilling constraints no longer allow further wells to be placed, triggers to place injection wells may be checked. Potential triggers are defined in FIG. 5. If the triggers are activated and sufficient drilling capacity exists, injection wells may be placed in locations depending on the activated trigger. This process repeats at the next timestep and until the end of simulation.

### Injection Wells Infill Drilling Workflow

FIG. 5 illustrates a diagram of injection wells infill drilling workflow, according to an embodiment. More particularly, FIG. 5 shows possible triggering conditions and resulting actions to place injection wells as part of the workflow described in FIG. 4. A subset of one or multiple triggers can be enabled to be considered in the workflow. Then, actions can be taken depending on the trigger defined. One trigger may lead to one or multiple actions, and one action can be linked to multiple triggers.

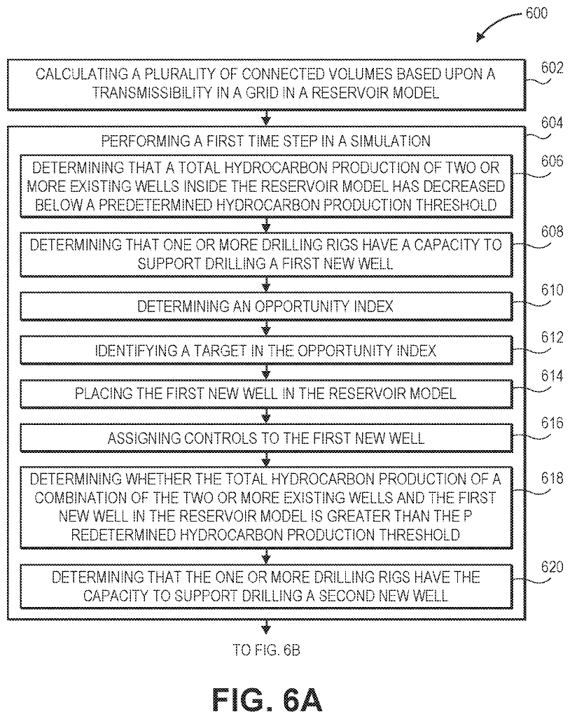

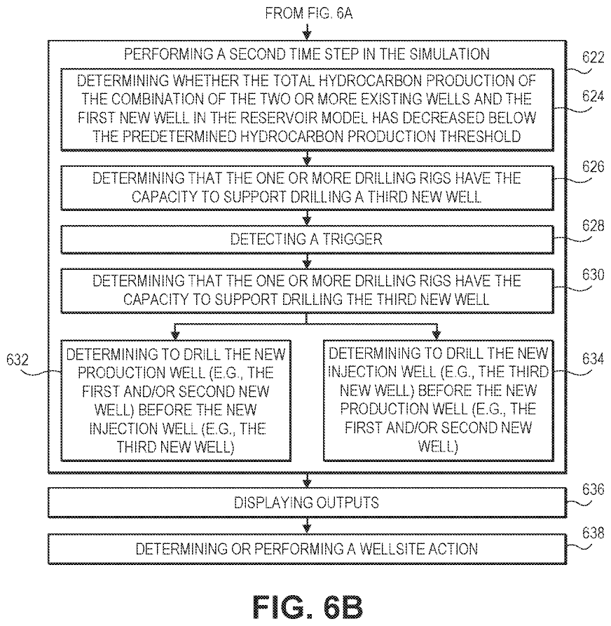

FIGS. 6A and 6B illustrate a flowchart of a method 600 for infill drilling, according to an embodiment. More particularly, the method 600 may simulate infill drilling of one or more (e.g., production) wells in a reservoir model before actual infill drilling takes place. The method 600 may be based at least partially upon FIGS. 4 and/or 5. An illustrative order of the method 600 is described below; however, one or more portions of the method 600 may be performed in a different order, performed simultaneously, repeated, or omitted. At least a portion of the method 600 may be performed by a computing system 700 (described below).

The method 600 may include calculating a plurality of connected volumes, as at 602. The connected volumes may be calculated based upon a transmissibility in a grid. The grid may include a plurality of grid cells in a reservoir model. The connected volumes may include the grid cells in the reservoir model that are hydraulically connected together. Each grid cell may include a plurality of properties. The properties may include, for example, porosity, permeability, saturation, or a combination thereof.

The method 600 may also include performing a first time step in a simulation, as at 604. The first time step may be performed after calculating the plurality of connected volumes.

Performing the first time step may include determining that a total hydrocarbon production of two or more existing wells inside the reservoir model has decreased below a predetermined hydrocarbon production threshold, as at 606. The total hydrocarbon production may include a rate at which hydrocarbons are produced.

Performing the first time step may also include determining that one or more drilling rigs have a capacity to support drilling a first new well, as at 608. The determination may be in response to determining that the total hydrocarbon production has decreased below the predetermined hydrocarbon production threshold. The first new well may be or include a production well.

Performing the first time step may also include determining an opportunity index, as at 610. The opportunity index may be determined in response to determining that one or more drilling rigs have the capacity. The opportunity index may be based upon the properties of the grid cells and/or one or more constant values that are unrelated to the properties of the grid cells.

Performing the first time step may also include identifying a target in the opportunity index, as at 612. The target may be or include one or more values in the opportunity index that are greater than a predetermined opportunity index threshold.

Performing the first time step may also include placing the first new well in the reservoir model, as at 614. The first new well may be placed in response to identifying the target. The first new well may be placed as part of a predetermined pattern or by itself in the target. The first new well may be placed so as to not collide or interfere with the two or more existing wells.

Performing the first time step may also include assigning controls to the first new well, as at 616. The controls may include production rate limits and/or pressure limits.

Performing the first time step may also include determining whether the total hydrocarbon production of a combination of the two or more existing wells and the first new well in the reservoir model is greater than the predetermined hydrocarbon production threshold, as at 618. The determination may be made after assigning the controls.

Performing the first time step may also include determining that the one or more drilling rigs have the capacity to support drilling a second new well, as at 620. The determination may be in response to determining that the total hydrocarbon production is less than the predetermined hydrocarbon production threshold. The second well new may be a production well.

The method 600 may also include performing a second time step in the simulation, as at 622. The second time step may be performed in response to determining that the total hydrocarbon production of the combination of the two or more existing wells and the first new well in the reservoir model is greater than the predetermined hydrocarbon production threshold.

Performing the second time step may include determining whether the total hydrocarbon production of the combination of the two or more existing wells and the first new well in the reservoir model has decreased below the predetermined hydrocarbon production threshold, as at 624. The method 600 may then loop back around to an earlier portion of the method 600 (e.g., to 608), but the action(s) may instead be performed for the second time step. One or more additional time steps (e.g., third time step, fourth time step, etc.) may also be performed (i.e., the method 600 may be iterative).

The method 600 (e.g., performing the first and/or second time step) may also include determining that the one or more drilling rigs have the capacity to support drilling a third new well, as at 626. The determination may be in response to determining that the total hydrocarbon production is greater than the predetermined hydrocarbon production threshold (e.g., from 618). The third new well may be an injection well.

The method 600 (e.g., performing the first and/or second time step) may also include detecting a trigger, as at 628. Examples of triggers are listed in FIG. 5.

The method 600 (e.g., performing the first and/or second time step) may also include determining that the one or more drilling rigs have the capacity to support drilling the third well, as at 630. The determination may be in response to the trigger. As mentioned above, the third new well may be an injection well.

The method 600 (e.g., performing the first and/or second time step) may also include determining to drill the new production well (e.g., the first and/or second new well) before the new injection well (e.g., the third new well), as at 632. The determination may cause the total hydrocarbon production of the combination of the two or more existing wells and the new production well in the reservoir model to remain above the predetermined hydrocarbon production threshold.

The method 600 (e.g., performing the first and/or second time step) may also include determining to drill the new injection well (e.g., the third new well) before the new production well (e.g., the first and/or second new well), as at 634. This determination may prioritize sustaining the production of the two or more existing wells over drilling the new production well(s), which may cause the total hydrocarbon production of the combination of the two or more existing wells in the reservoir model to remain above the predetermined hydrocarbon production threshold.

The method 600 may also include displaying outputs, as at 636. The outputs may be or include the outputs of any of the previous portions of the method 600. For example, the outputs may be or include the opportunity index, the target, the new well(s) in the reservoir model, or a combination thereof.

The method 600 may also include determining or performing a wellsite action, as at 638. The wellsite action may be determined or performed based at least partially upon any one or more of the previous portions of the method 600. More particularly, the wellsite action may be determined or performed based at least partially upon the first time step, the second time step, or both. For example, the wellsite action may be determined or performed based at least partially upon the opportunity index, the target, placing the new well(s), assigning the controls, determining that the one or more drilling rigs have the capacity to drill the new well(s), the total hydrocarbon production being greater than or less than the predetermined hydrocarbon production threshold, the trigger, or a combination thereof. In one embodiment, performing the wellsite action may include generating and/or transmitting a signal (e.g., using the computing system 700) which instructs or causes a physical action to take place. In another embodiment, performing the wellsite action may include physically performing the action (e.g., either manually or automatically). Illustrative physical actions may include, but are not limited to, selecting a location to drill the new well(s), determining risks while drilling the new well(s), drilling the new well(s), varying a trajectory of the new well(s), varying a weight on the bit of a downhole tool that is drilling the new well(s), or a combination thereof.

### Exemplary Computing System

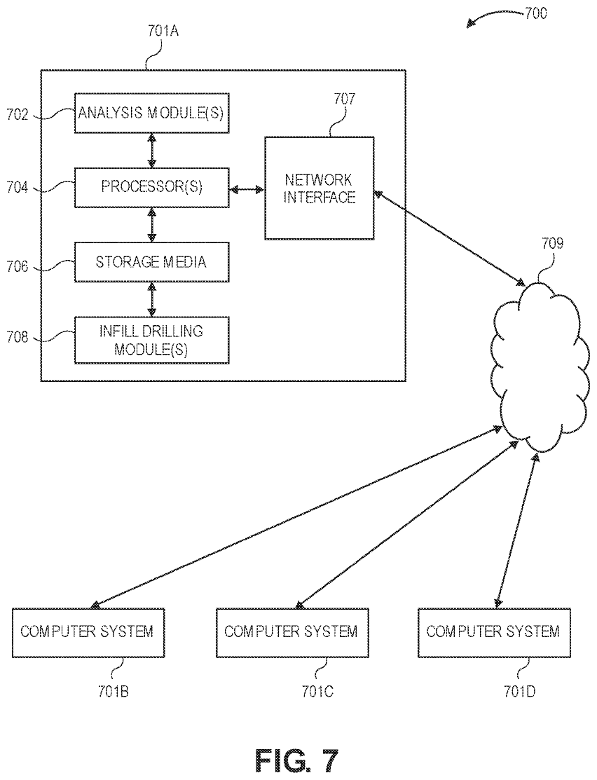

In some embodiments, any of the methods of the present disclosure may be executed by a computing system. FIG. 7 illustrates an example of such a computing system 700, in accordance with some embodiments. The computing system 700 may include a computer or computer system 701A, which may be an individual computer system 701A or an arrangement of distributed computer systems. The computer system 701A includes one or more analysis module(s) 702 configured to perform various tasks according to some embodiments, such as one or more methods disclosed herein. To perform these various tasks, the analysis module 702 executes independently, or in coordination with, one or more processors 704, which is (or are) connected to one or more storage media 706. The processor(s) 704 is (or are) also connected to a network interface 707 to allow the computer system 701A to communicate over a data network 709 with one or more additional computer systems and/or computing systems, such as 701B, 701C, and/or 701D (note that computer systems 701B, 701C and/or 701D may or may not share the same architecture as computer system 701A, and may be located in different physical locations, e.g., computer systems 701A and 701B may be located in a processing facility, while in communication with one or more computer systems such as 701C and/or 701D that are located in one or more data centers, and/or located in varying countries on different continents).

A processor can include a microprocessor, microcontroller, processor module or subsystem, programmable integrated circuit, programmable gate array, or another control or computing device.

The storage media 706 can be implemented as one or more computer-readable or machine-readable storage media. Note that while in the example embodiment of FIG. 7 storage media 706 is depicted as within computer system 701A, in some embodiments, storage media 706 may be distributed within and/or across multiple internal and/or external enclosures of computing system 701A and/or additional computing systems. Storage media 706 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 700 contains one or more seismic processing module(s) 708 that may perform at least a portion of one or more of the method(s) described above. It should be appreciated that computing system 700 is only one example of a computing system, and that computing system 700 may have more or fewer components than shown, may combine additional components not depicted in the example embodiment of FIG. 7, and/or computing system 700 may have a different configuration or arrangement of the components depicted in FIG. 7. The various components shown in FIG. 7 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

Geologic interpretations, models and/or other interpretation aids may be refined in an iterative fashion; this concept is applicable to embodiments of the present methods discussed herein. This can include use of feedback loops executed on an algorithmic basis, such as at a computing device (e.g., computing system 700, FIG. 7), and/or through manual control by a user who may make determinations regarding whether a given step, action, template, model, or set of curves has become sufficiently accurate for the evaluation of the subterranean three-dimensional geologic formation under consideration.

### CLAUSES

Clause 1: A method for autonomously simulating infill drilling of one or more wells, the method comprising: calculating a plurality of connected volumes in a reservoir model; determining that a total hydrocarbon production of one or more existing wells inside the reservoir model has decreased below a predetermined hydrocarbon production threshold; determining that one or more drilling rigs have a capacity to support drilling a first new well in response to determining that the total hydrocarbon production has decreased below the predetermined hydrocarbon production threshold, wherein the first new well comprises a production well; determining an opportunity index in response to determining that one or more drilling rigs have the capacity; identifying a target in the opportunity index; and placing the first new well in the reservoir model in response to identifying the target.

Clause 2: The method of claim 1, wherein the connected volumes are calculated based upon a transmissibility in a grid.

Clause 3: The method of claim 1 or 2, wherein the grid comprises a plurality of grid cells in the reservoir model.

Clause 4: The method of any of the preceding claims, wherein the connected volumes comprise the grid cells in the reservoir model that are hydraulically connected.

Clause 5: The method of claim 3, wherein each grid cell comprises a plurality of properties, and wherein the properties comprise porosity, permeability, saturation, or a combination thereof.

Clause 6: The method of claim 5, wherein the opportunity index is based upon the properties of the grid cells.

Clause 7: The method of any of the preceding claims, further comprising displaying the opportunity index, the target, the first new well in the reservoir model, or a combination thereof.

Clause 8: The method of any of the preceding claims, further comprising performing a wellsite action.

Clause 9: The method of claim 8, wherein performing the wellsite action comprises generating a signal to control drilling of the first new well at a wellsite.

Clause 10: The method of claim 8, wherein performing the wellsite action comprises drilling the first new well at a wellsite.

Clause 11: A computing system, comprising: one or more processors; and a memory system comprising one or more non-transitory computer-readable media storing instructions that, when executed by at least one of the one or more processors, cause the computing system to perform operations, the operations comprising: calculating a plurality of connected volumes, wherein the connected volumes are calculated based upon a transmissibility in a grid, wherein the grid comprises a plurality of grid cells in a reservoir model, wherein the connected volumes comprise the grid cells in the reservoir model that are hydraulically connected, wherein each grid cell comprises a plurality of properties, and wherein the properties comprise porosity, permeability, saturation, or a combination thereof; and performing a first time step in a simulation, wherein the first time step is performed after calculating the plurality of connected volumes, wherein performing the first time step comprises: determining that a total hydrocarbon production of one or more existing wells inside the reservoir model has decreased below a predetermined hydrocarbon production threshold, wherein the total hydrocarbon production comprises a rate at which hydrocarbons are produced; determining that one or more drilling rigs have a capacity to support drilling a first new well in response to determining that the total hydrocarbon production has decreased below the predetermined hydrocarbon production threshold, wherein the first new well comprises a production well; determining an opportunity index in response to determining that one or more drilling rigs have the capacity; identifying a target in the opportunity index; and placing the first new well in the reservoir model in response to identifying the target.

Clause 12: The computing system of claim 11, wherein the opportunity index is based upon the properties of the grid cells and one or more constant values that are unrelated to the properties of the grid cells.

Clause 13: The computing system of claim 11 or 12, wherein the target comprises one or more values in the opportunity index that are greater than a predetermined opportunity index threshold.

Clause 14: The computing system of any of claims 11-13, wherein the operations further comprise: determining that the total hydrocarbon production of a combination of the two or more existing wells and the first new well in the reservoir model is less than the predetermined hydrocarbon production threshold; determining that the one or more drilling rigs have the capacity to support drilling a second new well in response to determining that the total hydrocarbon production is less than the predetermined hydrocarbon production threshold, wherein the second well new comprises a production well; and placing the second new well in the reservoir model.

Clause 15: The computing system of any of claims 11-14, wherein the operations further comprise: determining that the total hydrocarbon production of a combination of the two or more existing wells and the first new well in the reservoir model is greater than the predetermined hydrocarbon production threshold; determining that the one or more drilling rigs have the capacity to support drilling a second new well in response to determining that the total hydrocarbon production is greater than the predetermined hydrocarbon production threshold, wherein the second new well comprises an injection well; and placing the second new well in the reservoir model.

Clause 16: A computer program comprising instructions that, when executed by a computer processor of a computing device, causes the computing device to perform operations, the operations comprising: calculating a plurality of connected volumes, wherein the connected volumes are calculated based upon a transmissibility in a grid, wherein the grid comprises a plurality of grid cells in a reservoir model, wherein the connected volumes comprise the grid cells in the reservoir model that are hydraulically connected, wherein each grid cell comprises a plurality of properties, and wherein the properties comprise porosity, permeability, saturation, or a combination thereof; performing a first time step in a simulation, wherein the first time step is performed after calculating the plurality of connected volumes, wherein performing the first time step comprises: determining that a total hydrocarbon production of two or more existing wells inside the reservoir model has decreased below a predetermined hydrocarbon production threshold, wherein the total hydrocarbon production comprises a rate at which hydrocarbons are produced; determining that one or more drilling rigs have a capacity to support drilling a first new well in response to determining that the total hydrocarbon production has decreased below the predetermined hydrocarbon production threshold, wherein the first new well comprises a production well; determining an opportunity index in response to determining that one or more drilling rigs have the capacity, wherein the opportunity index is based upon the properties of the grid cells and one or more constant values that are unrelated to the properties of the grid cells; identifying a target in the opportunity index, wherein the target comprises one or more values in the opportunity index that are greater than a predetermined opportunity index threshold; placing the first new well in the reservoir model in response to identifying the target, wherein the first new well is placed as part of a predetermined pattern in the target or by itself in the target, and wherein the first new well is placed so as to not collide or interfere with the two or more existing wells; assigning controls to the first new well, wherein the controls comprise production rate limits and pressure limits; and determining that the total hydrocarbon production of a combination of the two or more existing wells and the first new well in the reservoir model is greater than the predetermined hydrocarbon production threshold after assigning the controls; and performing a second time step in the simulation in response to determining that the total hydrocarbon production of the combination of the two or more existing wells and the first new well in the reservoir model is greater than the predetermined hydrocarbon production threshold.

Clause 17: The computer program of claim 16, wherein the operations further comprise determining that the one or more drilling rigs have the capacity to support drilling a second new well in response to determining that the total hydrocarbon production is greater than the predetermined hydrocarbon production threshold, and wherein the second new well comprises an injection well.

Clause 18: The computer program of claim 16 or 17, wherein the operations further comprise: detecting a trigger, wherein the trigger comprises an oil production rate declining, a gas production rate increasing, a pressure declining in one of the two or more existing wells or the first new well, or a combination thereof; and determining that the one or more drilling rigs have the capacity to support drilling a second new well in response to the trigger, wherein the second new well comprises an injection well.

Clause 19: The computer program of any of claims 16-18, wherein the operations further comprise determining to drill the first new well before drilling a new injection well, which causes the total hydrocarbon production of the combination of the two or more existing wells and the first new well in the reservoir model to remain above the predetermined hydrocarbon production threshold.

Clause 20: The computer program of any of claims 16-19, wherein the operations further comprise determining to drill a new injection well before the first new well, which causes the total hydrocarbon production of the combination of the two or more existing wells in the reservoir model to remain above the predetermined hydrocarbon production threshold.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for autonomously simulating infill drilling of one or more wells, the method comprising:
calculating a plurality of connected volumes in a reservoir model;
determining that a total hydrocarbon production of one or more existing wells inside the reservoir model has decreased below a predetermined hydrocarbon production threshold;
determining that one or more drilling rigs have a capacity to support drilling a first new well in response to determining that the total hydrocarbon production has decreased below the predetermined hydrocarbon production threshold, wherein the first new well comprises a production well;
determining an opportunity index in response to determining that one or more drilling rigs have the capacity;
identifying a target in the opportunity index; and
placing the first new well in the reservoir model in response to identifying the target.

2. The method of claim 1, wherein the connected volumes are calculated based upon a transmissibility in a grid.

3. The method of claim 2, wherein the grid comprises a plurality of grid cells in the reservoir model.

4. The method of claim 3, wherein the connected volumes comprise the grid cells in the reservoir model that are hydraulically connected.

5. The method of claim 3, wherein each grid cell comprises a plurality of properties, and wherein the properties comprise porosity, permeability, or saturation.

6. The method of claim 5, wherein the opportunity index is based upon the properties of the grid cells.

7. The method of claim 1, further comprising displaying the opportunity index, the target, or the first new well in the reservoir model.

8. The method of claim 1, further comprising performing a wellsite action.

9. The method of claim 8, wherein performing the wellsite action comprises generating and transmitting a signal to control drilling of the first new well at a wellsite.

10. The method of claim 8, wherein performing the wellsite action comprises drilling the first new well at a wellsite.

11. A computing system, comprising:
one or more processors; and
a memory system comprising one or more non-transitory computer-readable media storing instructions that, when executed by at least one of the one or more processors, cause the computing system to perform operations, the operations comprising:
calculating a plurality of connected volumes, wherein the connected volumes are calculated based upon a transmissibility in a grid, wherein the grid comprises a plurality of grid cells in a reservoir model, wherein the connected volumes comprise the grid cells in the reservoir model that are hydraulically connected, wherein each grid cell comprises a plurality of properties, and wherein the properties comprise porosity, permeability, or saturation; and
performing a first time step in a simulation, wherein the first time step is performed after calculating the plurality of connected volumes, wherein performing the first time step comprises:
determining that a total hydrocarbon production of one or more existing wells inside the reservoir model has decreased below a predetermined hydrocarbon production threshold, wherein the total hydrocarbon production comprises a rate at which hydrocarbons are produced;
determining that one or more drilling rigs have a capacity to support drilling a first new well in response to determining that the total hydrocarbon production has decreased below the predetermined hydrocarbon production threshold, wherein the first new well comprises a production well;
determining an opportunity index in response to determining that one or more drilling rigs have the capacity;
identifying a target in the opportunity index; and
placing the first new well in the reservoir model in response to identifying the target.

12. The computing system of claim 11, wherein the opportunity index is based upon the properties of the grid cells and one or more constant values that are unrelated to the properties of the grid cells.

13. The computing system of claim 11, wherein the target comprises one or more values in the opportunity index that are greater than a predetermined opportunity index threshold.

14. The computing system of claim 11, wherein the operations further comprise:
determining that the total hydrocarbon production of a combination of the two or more existing wells and the first new well in the reservoir model is less than the predetermined hydrocarbon production threshold;
determining that the one or more drilling rigs have the capacity to support drilling a second new well in response to determining that the total hydrocarbon production is less than the predetermined hydrocarbon production threshold, wherein the second well new comprises a production well; and
placing the second new well in the reservoir model.

15. The computing system of claim 11, wherein the operations further comprise:
determining that the total hydrocarbon production of a combination of the two or more existing wells and the first new well in the reservoir model is greater than the predetermined hydrocarbon production threshold;
determining that the one or more drilling rigs have the capacity to support drilling a second new well in response to determining that the total hydrocarbon production is greater than the predetermined hydrocarbon production threshold, wherein the second new well comprises an injection well; and
placing the second new well in the reservoir model.

16. A computer program comprising instructions that, when executed by a computer processor of a computing device, causes the computing device to perform operations, the operations comprising:
calculating a plurality of connected volumes, wherein the connected volumes are calculated based upon a transmissibility in a grid, wherein the grid comprises a plurality of grid cells in a reservoir model, wherein the connected volumes comprise the grid cells in the reservoir model that are hydraulically connected, wherein each grid cell comprises a plurality of properties, and wherein the properties comprise porosity, permeability, and saturation;
performing a first time step in a simulation, wherein the first time step is performed after calculating the plurality of connected volumes, wherein performing the first time step comprises:
determining that a total hydrocarbon production of two or more existing wells inside the reservoir model has decreased below a predetermined hydrocarbon production threshold, wherein the total hydrocarbon production comprises a rate at which hydrocarbons are produced;
determining that one or more drilling rigs have a capacity to support drilling a first new well in response to determining that the total hydrocarbon production has decreased below the predetermined hydrocarbon production threshold, wherein the first new well comprises a production well;
determining an opportunity index in response to determining that one or more drilling rigs have the capacity, wherein the opportunity index is based upon the properties of the grid cells and one or more constant values that are unrelated to the properties of the grid cells;
identifying a target in the opportunity index, wherein the target comprises one or more values in the opportunity index that are greater than a predetermined opportunity index threshold;
placing the first new well in the reservoir model in response to identifying the target, wherein the first new well is placed as part of a predetermined pattern in the target or by itself in the target, and wherein the first new well is placed so as to not collide or interfere with the two or more existing wells;
assigning controls to the first new well, wherein the controls comprise production rate limits and pressure limits; and
determining that the total hydrocarbon production of a combination of the two or more existing wells and the first new well in the reservoir model is greater than the predetermined hydrocarbon production threshold after assigning the controls; and
performing a second time step in the simulation in response to determining that the total hydrocarbon production of the combination of the two or more existing wells and the first new well in the reservoir model is greater than the predetermined hydrocarbon production threshold.

17. The computer program of claim 16, wherein the operations further comprise determining that the one or more drilling rigs have the capacity to support drilling a second new well in response to determining that the total hydrocarbon production is greater than the predetermined hydrocarbon production threshold, and wherein the second new well comprises an injection well.

18. The computer program of claim 16, wherein the operations further comprise:
detecting a trigger, wherein the trigger comprises an oil production rate declining, a gas production rate increasing, and a pressure declining in one of the two or more existing wells or the first new well; and
determining that the one or more drilling rigs have the capacity to support drilling a second new well in response to the trigger, wherein the second new well comprises an injection well.

19. The computer program of claim 16, wherein the operations further comprise determining to drill the first new well before drilling a new injection well, which causes the total hydrocarbon production of the combination of the two or more existing wells and the first new well in the reservoir model to remain above the predetermined hydrocarbon production threshold.

20. The computer program of claim 16, wherein the operations further comprise determining to drill a new injection well before the first new well, which causes the total hydrocarbon production of the combination of the two or more existing wells in the reservoir model to remain above the predetermined hydrocarbon production threshold.
